(19) United States
(12) Patent Application Publication
(10) Pub. No.: US 2008/0093402 A1
(43) Pub. Date: Apr. 24, 2008

(54) Roof Container Lock That is Dependent on Dynamic Pressure

(76) Inventors: Guenther Fritsche, Postbauer-Heng (DE); Alexander Emmerling, Sulzbuerg (DE)

Correspondence Address: JORDAN AND HAMBURG LLP, 122 EAST 42ND STREET, SUITE 4000, NEW YORK, NY, 10168, US

(21) Appl. No.: 11/661,066

(22) PCT Filed: Aug. 30, 2005
(86) PCT No.: PCT/DE05/01512

§ 371 Date: Apr. 4, 2007

(30) Foreign Application Priority Data
Sep. 11, 2004 (DE) 10 2004 043 962.1

(51) Int. Cl. B60R 9/00

(52) U.S. Cl. 224/315

(57) ABSTRACT

Safety locking mechanism for roof containers to prevent the edge of the container tipping up as the result of excessively high wind pressure or of a failure of the normal locking device while the vehicle is moving, for which a locking element at a container part engages a counter element at a different part of the container, the locking element, disposed at a container part and pretensioned elastically in a not engaged position, being constructed and disposed, so that it is swiveled into its locking position by head wind only while the vehicle is moving.

### BACKGROUND OF THE INVENTION

The invention relates to a safety locking mechanism for roof containers to prevent the edge of the container tipping up as the result of excessively high wind pressure or of a failure of the normal locking device while the vehicle is moving, for which a locking element at a container part engages a counter element at a different part of the container.

For a safety locking mechanism of the type mentioned initially, which has become known from the utility patent DE 295 08 826 U1, a securing hook, which can be swiveled in and, in the swiveled-in securing position, is hinged at the edge of the lid and freely grips below the sealing edge of the lower part and, when the lid is swiveled up, hooks under the edge of the bottom part. The construction is such, that this securing hook is swiveled under its own weight into the locking position, in which it rests below the bordered edge of the lower part of the roof container. The safety locking mechanism is therefore active constantly. When the vehicle is stationary, the user, for opening the roof container, must first make this safety locking mechanism inoperative by swiveling the securing hook back. However, this may, in turn, create difficulties when the closing device of the lid is actuated and the lid is swiveled up.

### SUMMARY OF THE INVENTION

It is therefore an object of the invention to develop a closing device of the above-mentioned type so that it is ineffective when the vehicle is stationary and effective only when the vehicle is moving.

To accomplish this objective, provisions are made pursuant to the invention so that a locking element, disposed at a container part and pretensioned elastically in a not engaged position, is constructed and disposed, so that it is swiveled into its locking position by head wind only while the vehicle is moving.

Quite generally, the locking element may be connected with an actuating element of any type, which depends on the dynamic pressure and, starting out from the increasing dynamic pressure, moves the locking element as the speed of the vehicle increases from the not engaged position into the engaged position, with additional safety locking of the container lid at the lower part of the container.

In the simplest case, the locking element, disposed at a container part, is a locking hook or a locking pin, which grips above or below an edge flange of the counterpart of the container or engages a transverse recess of this counterpart of the container.

Although, in principle, the locking part could be disposed at any part of the container, it has proven to be particularly appropriate in practice to dispose the locking part at the upper part of the roof container.

A particularly simple and operationally reliable version of an inventive safety locking mechanism arises in a development of the invention owing to the fact that the locking element is disposed at a pressure adjusting plate, which is acted upon by the head wind and can be shifted into the locking position. In turn, the pressure adjusting plate is mounted elastically resetably at a foot part, which can be fastened to a container part.

In accordance with a first development of the present invention, this pressure adjusting plate, constructed as a wing plate, may be mounted pivotably preferably as a foot part, which is constructed as a foot plate. The pivot axis may be disposed horizontally, that is, parallel to the junction plane of the container, as well as vertically, that is, perpendicularly to the junction plane of the container. However, in practice, it has proven to be particularly appropriate to use the horizontal pivot mounting axis.

In the case of a different embodiment of the invention, the pressure adjusting plate forms the piston of a dynamic pressure cylinder, which is disposed, for example, at the front edge of the roof container. The piston rod of this dynamic pressure cylinder either carries the locking element or forms this locking element directly.

Finally, it is also still within the scope of the invention that the pressure adjusting plate is a spring-elastic membrane, which carries the locking element.

Further advantages and details of the invention arise out of the following description of some embodiments, as well as from the drawings.

### BRIEF DESCRIPTION OF THE DRAWINGS

FIG. 1 shows a view of a roof container from the front with an inventive safety locking mechanism, which is disposed at the lid for gripping below the sealing edge of the lower part of the container in the position at rest with a stationary vehicle in accordance with a first embodiment,

FIG. 2 shows a view of the roof container from the front with the inventive safety locking mechanism swiveled into the locking position while the vehicle is moving,

FIG. 3 shows a step along the line III-III in FIG. 1, the position of the locking hook being drawn by broken lines in the locking position of FIG. 2,

FIG. 4 shows a section, corresponding to FIG. 3, in a situation, in which the roof container has been raised slightly at the front end by the head wind until the safety locking mechanism commences to act,

FIG. 5 shows an enlarged detailed view of the pivot mounting of the arrangement of FIGS. 1 to 4 with the return spring.

FIG. 6 shows a perspective exploded representation of a second embodiment of a construction of an inventive safety locking mechanism, which is constructed as a dynamic pressure cylinder,

FIG. 7 shows a section through the front end of the roof container with the safety locking mechanism of FIG. 6 in the position at rest,

FIG. 8 shows a section, corresponding to that of FIG. 7, through a further embodiment of an inventive safety locking mechanism, for which the pressure adjusting plate is constructed as a spring-elastic membrane, and

FIGS. 9 and 10 show diagrammatic representations of the development of a safety locking mechanism with pivotable wing plate, for which the pivot axis is disposed vertically.

### DESCRIPTION OF THE PREFERRED EMBODIMENTS

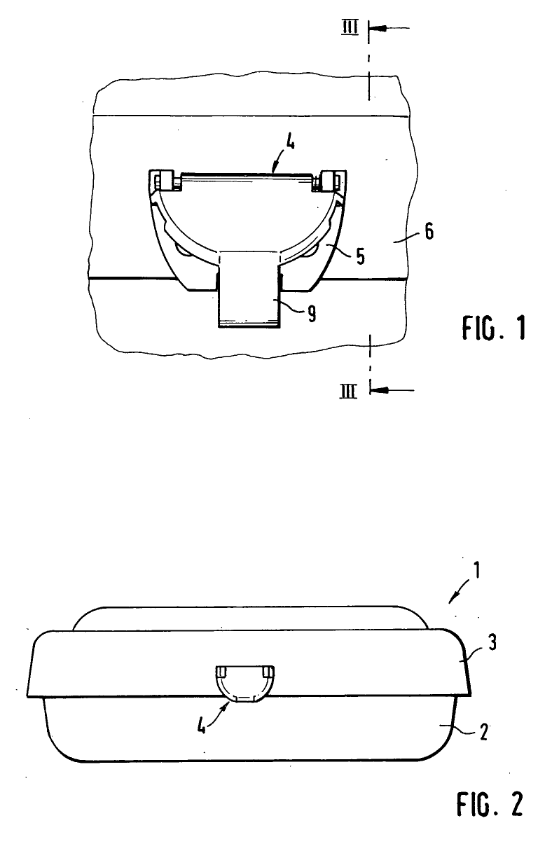

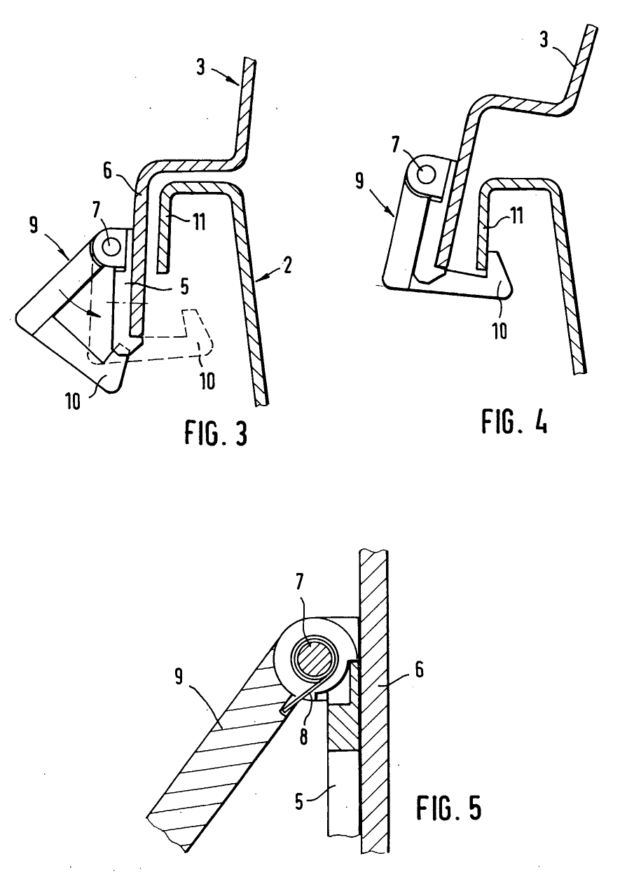

For the first embodiment of the present invention, shown in FIGS. 1 to 5, a roof container 1, with a lower part 2, and a lid 3, which is pivotably hinged to the lower part 2, may be recognize, to begin with. In this connection, it is immaterial whether the lid 3 can be hinged about the rear edge, which is remote from the recognizable front side of the roof container 1, or about a side edge of the lid 3. An additional, inventive safety locking mechanism, which prevents the lid 3 being swiveled up at the front end of the container relative to the lower part 2 by the head wind while the vehicle is moving, is indicated at 4. For this purpose, the safety locking mechanism 4 is constructed so that, when at rest, that is, when the vehicle is stationary (shown in FIGS. 1 and 3 by solid lines), it is disposed in an unlocked position, in which it is pretensioned by a spring, and swiveled into the locking position (shown in FIGS. 2, 3 by the broken lines and in FIG. 4) only by the head wind.

The safety locking mechanism 4 of FIGS. 1 to 5 comprises a foot plate 5, which is fastened to the edge 6 of the lid 3, and a pressure adjusting plate, which is constructed here as a wing plate 9, carries a locking hook 10 and is mounted pivotably over a hinged bearing 7 with a return spring 8. This locking hook is in the position at rest, that is, with the vehicle stationary, it is disposed in the outwardly swiveled position, shown by solid lines in FIG. 3, and held in this position by the return spring, so that the lid 3 can be opened readily. In other words, the safety locking mechanism is not active at all when the vehicle is stationary.

Only while the vehicle is moving is the wing plate 9 swiveled to the right by the head wind into the position drawn by a broken lines in FIG. 3, so that, while the vehicle is moving, the locking hook 10 is always disposed underneath a sealing edge 11 of the lower container part 2, so that, when the head wind is too high and the lid 3 actually wants to open up somewhat in the upward direction, the catching situation, sketched in FIG. 4, sets in, for which the locking hook 10, after only a relatively slight opening lift of the lid 3, reliably prevents any further opening up.

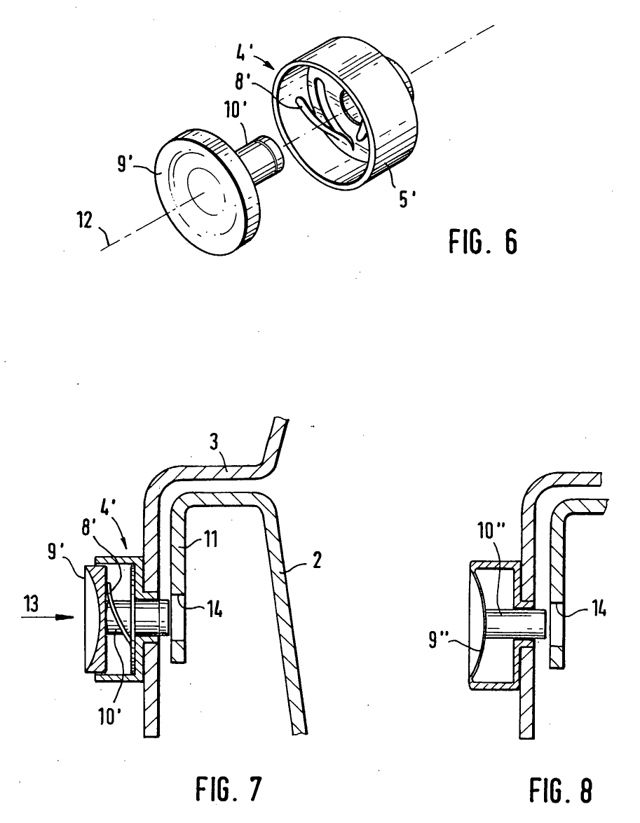

FIGS. 6 and 7 show a second embodiment, for which the safety locking mechanism 4′ has a foot part 5′, which is constructed as a dynamic pressure piston, and a piston 9′, which forms a pressure adjusting plate and can be shifted by the head wind, acting in the direction of an axis 12, against a spring arrangement 8′. In this case, the piston rod 10 forms a locking pin directly, which, placed below the bottom of the dynamic pressure cylinder, can be pressed out of the position of rest, shown in FIG. 7 at the front tip of the roof container, by the head wind acting in the direction of the arrow 13 into a locking recess 14 of the sealing edge 11 of the lower container part 2.

FIG. 8 shows an alternative, for which, instead of a piston that can be displaced by the wind pressure, a spring-elastic membrane 9″ is provided, to which a locking pin 10″ is fastened directly. Here also, the construction is such that, in the position at rest, that is, when the vehicle is stationary, the locking pin 10″ does not yet engaged the locking recess 14 of the lower container part 10″ and does so only when, at a particular speed, the wind pressure is sufficient, so that the membrane is deflected correspondingly. After all, the locking is required only while the vehicle is moving, since the prevention of the opening of the lid by the headwind while the vehicle is moving presupposes a certain minimum speed.

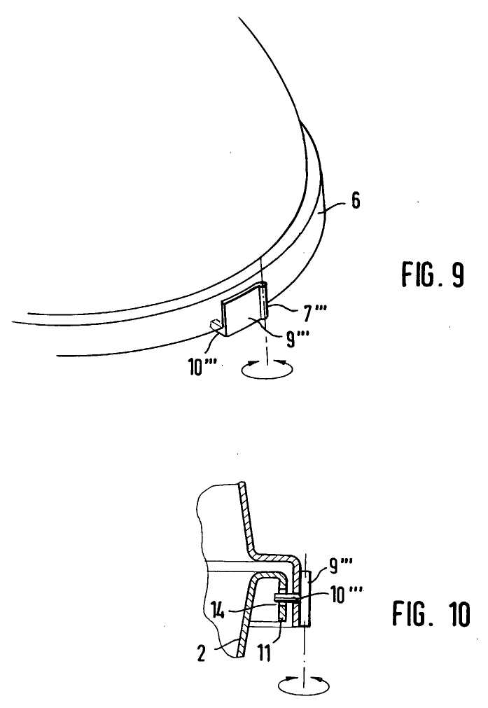

FIGS. 9 and 10 diagrammatically show an embodiment of an inventive safety locking mechanism with a wing plate similar to that shown in FIGS. 1 to 5. However, the pivot axis of the swiveling plate 9′″ extends not horizontally, that is, parallel to the junction plane of the container, but vertically, that is, perpendicularly to this junction plane of the container. For the embodiment of FIG. 9, the wing plate 9′″ is constructed so that it protrudes beyond the edge 6 of the container lid and, at the left end, remote from the hinged bearing 7′″, carries a locking element 10′″, which grips below the sealing edge of the lower part. On the other hand, for the embodiment of FIG. 10, the wing plate, which in this case need not lap below the lid edge 6, is provided with a locking pin 10′″, which, similarly to the embodiments of FIGS. 6 to 8, engages a recess 14 of the sealing edge 11 of the lower container part 2.

1.-10. (canceled)

11. A safety locking mechanism for a vehicle roof container having a lower part and a lid part hinged to the lower part, the safety locking mechanism comprising:
a counter element disposed at a one of the lid part or the lower part of the roof container; and
a locking element movably mounted on an other one of the lid part or the lower part for movement into selective locking engagement with said counter element, said locking element being urged by biasing into a non-engaging position with said counter element, said locking element being movable against said biasing into an engaged locking position by operation of a head wind present while the vehicle is moving, thereby preventing a tipping up of the lid part of the container as the result of excessively high wind pressure or of a failure of a normal locking device while the vehicle is moving,

12. A safety locking mechanism according to claim 11, further comprising an actuating element connected with the locking element which is responsive to the head wind for imparting engagement movement to said locking element.

13. A safety locking mechanism according to claim 11, wherein:
the counter element includes an edge flange; and
the locking element includes a locking hook or a locking pin which grips above or below said edge flange of the counter element of the container or engages a transverse recess in said edge flange of the counter element.

14. A safety locking mechanism according to claim 12, wherein:
the counter element includes an edge flange; and
the locking element includes a locking hook or a locking pin which grips above or below said edge flange of the counter element of the container or engages a transverse recess in said edge flange of the counter element.

15. A safety locking mechanism according to claim 11, wherein:
the locking element includes a foot part fastenable to said other one of the lid part or the lower part; and
the locking element further includes a pressure adjusting plate which is acted upon by the head wind such that the locking element is shiftable into the locking position, said pressure adjusting plate being mounted elastically to said foot part.

16. A safety locking mechanism according to claim 12, wherein:
the locking element includes a foot part fastenable to said other one of the lid part or the lower part; and
the locking element further includes a pressure adjusting plate which is acted upon by the head wind such that the locking element is shiftable into the locking position, said pressure adjusting plate being mounted elastically to said foot part.

17. A safety locking mechanism according to claim 15, wherein the pressure adjusting plate comprises a wing plate mounted pivotably at the foot part.

18. A safety locking mechanism according to claim 15, wherein the foot part comprises a foot plate.

19. A safety locking mechanism according to claim 17, wherein a pivot axis of the wind plate is disposed horizontally, parallel to a junction plane of the lid part and the lower part of the roof container.

20. A safety locking mechanism according to claim 18, wherein a pivot axis of the wind plate is disposed horizontally, parallel to a junction plane of the lid part and the lower part of the roof container.

21. A safety locking mechanism according to claim 17, wherein a pivot axis of the wing plate is disposed vertically, perpendicular to the junction plane of the container.

22. A safety locking mechanism according to claim 18, wherein a pivot axis of the wing plate is disposed vertically, perpendicular to the junction plane of the container.

23. A safety locking mechanism according to claim 15, wherein the pressure adjusting plate forms a piston of a dynamic pressure cylinder which includes a piston rod, the locking element being carried, or formed directly, on said piston rod.

24. A safety locking mechanism according to claim 16, wherein the pressure adjusting plate forms a piston of a dynamic pressure cylinder which includes a piston rod, the locking element being carried, or formed directly, on said piston rod.

25. A safety locking mechanism according to claim 15, wherein the pressure adjusting plate comprises a spring-elastic membrane which carries the locking element.

26. A safety locking mechanism according to claim 16, wherein the pressure adjusting plate comprises a spring-elastic membrane which carries the locking element.

27. A safety locking mechanism according to claim 1, wherein the locking element is disposed at the lid part.

28. A safety locking mechanism according to claim 1, wherein the counter element is integral with said one of the lid part or the lower part of the roof container.
